(19) United States
(12) Patent Application Publication
(10) Pub. No.: US 2006/0169536 A1
(43) Pub. Date: Aug. 3, 2006

(54) Portable ladder lift apparatus

(76) Inventor: Brent A. Davis, Clearwater, FL (US)

Correspondence Address: LARSON AND LARSON, 11199 69TH STREET NORTH, LARGO, FL, 33773, US

(21) Appl. No.: 11/038,639

(22) Filed: Jan. 19, 2005

(51) Int. Cl. E06C 5/00

(52) U.S. Cl. 182/127

(57) ABSTRACT

An extension ladder is pivotably mounted on a trailer towed by a motor vehicle. A hydraulic lift elevates the ladder after multiple side stabilization arms have been deployed outwardly from the trailer frame. Hydraulic jacks at the ends of the stabilization arms prevent the trailer from tipping. A rear upwardly directed frame has a pair of tie-down brackets to hold the ladder in place when being moved. The ladder base pivots on a U-shaped bracket so it can be raised or turned as needed. A brace attached to the ladder at one end and to a brace support at another end supports the ladder lifted to an elevated position by a hydraulic jack.

### BACKGROUND OF THE INVENTION

The present invention relates to portable ladders. More specifically, it refers to an extension ladder supported on and pivoting on a trailer attachable to a motor vehicle.

### DESCRIPTION OF THE PRIOR ART

U.S. Pat. No. 1,908,969 describes a ladder mounted on a truck and rotated by a driven pinion. The ladder is elevated through the use of air cylinders. U.S. Pat. No. 2,933,150 describes a power driven extension ladder. U.S. Pat. No. 3,088,543 describes a ladder lift on a truck in which a winch assembly lifts the ladder. U.S. Pat. No. 4,877,108 describes a hydraulic ladder brace for use on small vehicles. Although the prior art describes power means for elevating extension ladders and in some cases with ladders positioned on trucks, there has been no suggestion of mounting a pivotable extension ladder on a trailer detachable from a motor vehicle to allow for use of the power driven ladder in narrow locations where a truck or motor vehicle cannot gain entrance. Such an apparatus is needed, particularly for tree trimming in restricted areas.

### SUMMARY OF THE INVENTION

The present invention solves the problem of ladder access in restricted areas by providing a portable ladder lift apparatus. A rotatable extension ladder is mounted on an elongated trailer towable to the work area by a motor vehicle, then detached from the motor vehicle and wheeled in manually to the location where the extension ladder is needed. The elongated trailer has multiple side extendable legs for stabilizing the trailer when the ladder is extended. A pivotable bracket attached to the trailer frame supports the lower portion of the ladder. A hydraulic lift raises the ladder and a first end of a brace supports an upper portion of the ladder. A second end of the brace locks into a locking frame attached to the pivotable bracket.

### BRIEF DESCRIPTION OF THE DRAWINGS

This invention can be best understood by those having ordinary skill in the art by reference to the following detailed description when considered in conjunction with the accompanying drawings in which:

FIG. 1 is an isometric view of the portable ladder lift apparatus in an extended position on a trailer.

FIG. 2 is an isometric view of the rear portion of the apparatus shown in FIG. 1.

FIG. 3 is an isometric view of the apparatus shown in FIG. 1 with the ladder in a transporting mode.

FIG. 4 is an isometric view of a front portion of the portable ladder lift apparatus shown in FIG. 1.

FIG. 5 is an isometric view of the portable ladder lift apparatus in an extended and rotated position on a trailer.

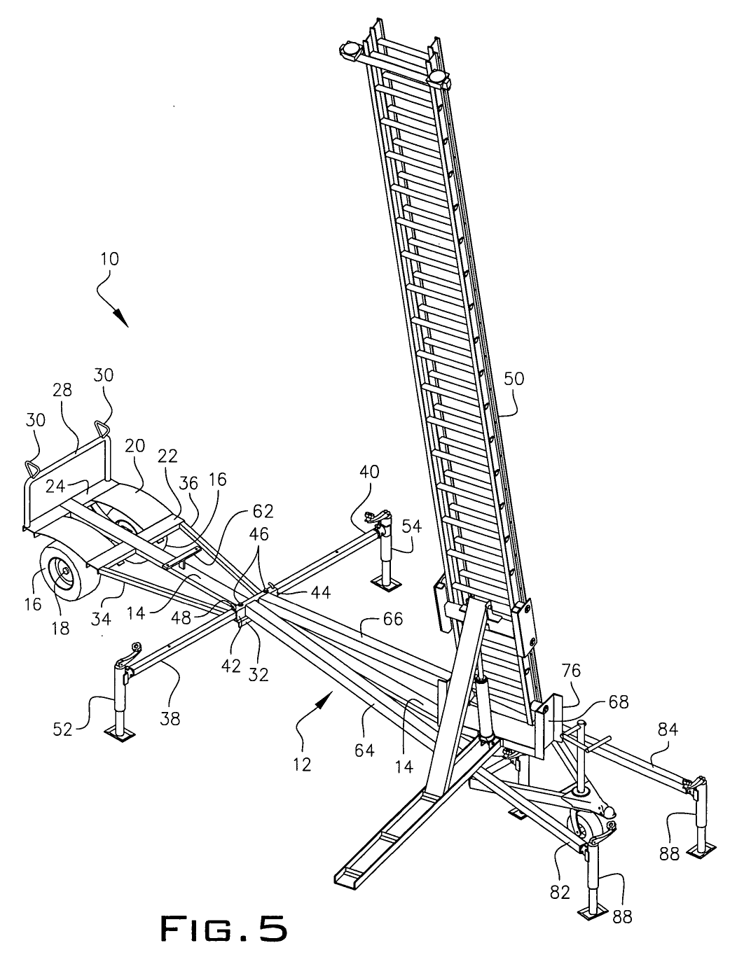

FIG. 6 is an isometric view of a front portion of the apparatus shown in FIG. 5.

FIG. 7 is an isometric view of the portable ladder lift apparatus of this invention in a collapsed position on a trailer.

FIG. 8 is a view looking upwardly of the apparatus front portion shown in FIG. 4.

FIG. 9 is an exploded view of the front portion of the apparatus shown in FIG. 4.

### DETAILED DESCRIPTION OF THE INVENTION

Throughout the following detailed description, the same reference numerals refer to the same elements in all figures.

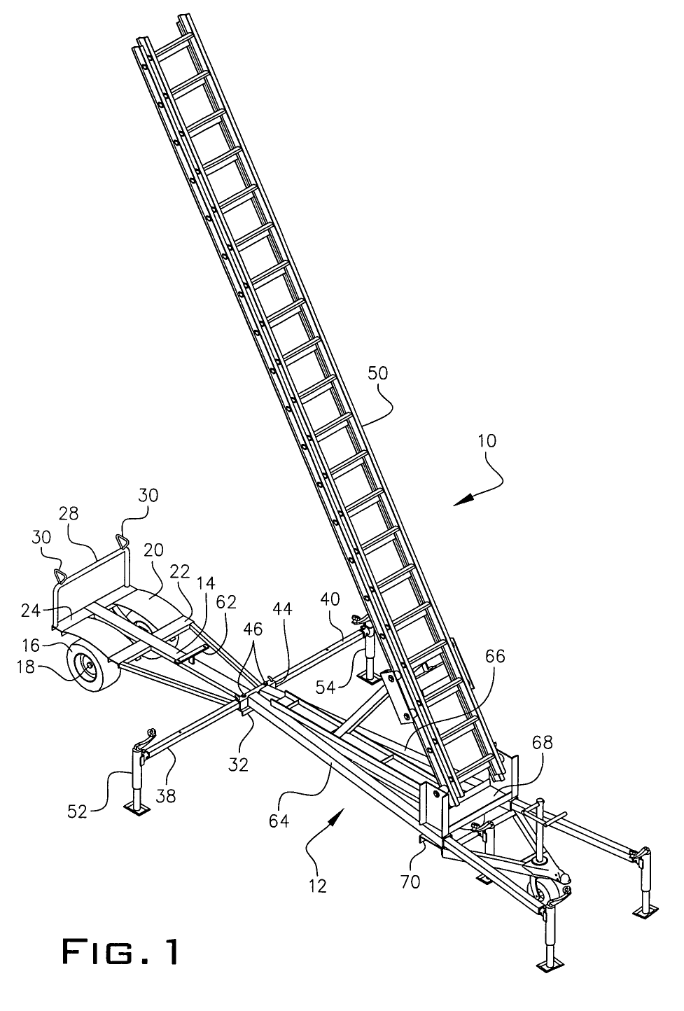

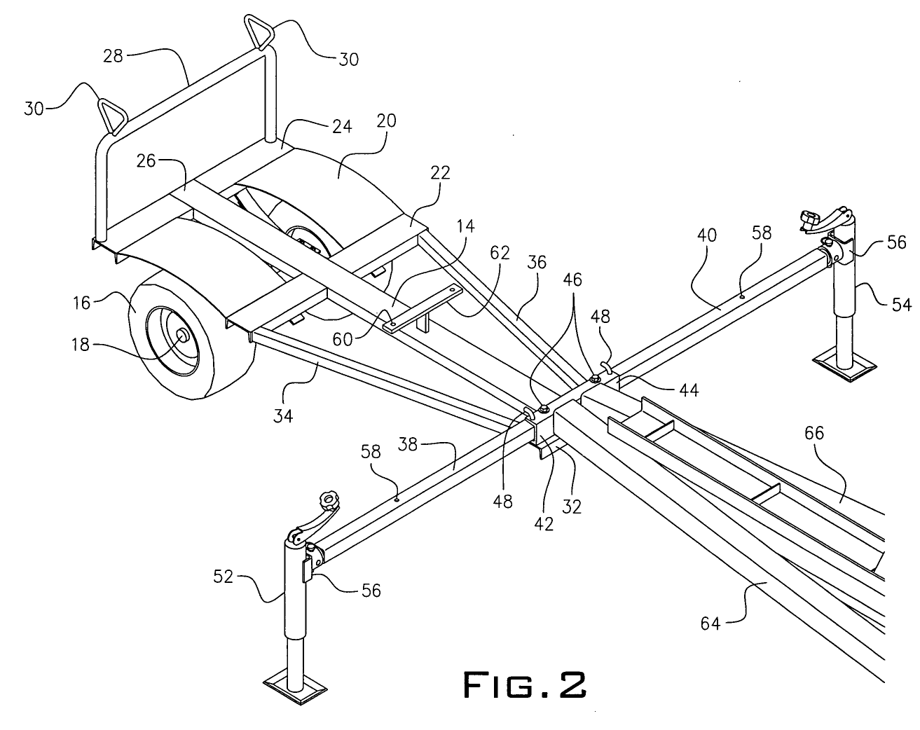

Referring to FIGS. 1 and 2, the apparatus 10 contains an extendable ladder 50 and a trailer 12 with an elongated central frame member 14. A pair of wheels 16 turning on axle 18 support a rear portion 20 of the trailer 12. A second pair of wheels could be added for additional weight support. A first transverse frame member 24 is bolted or welded to a rear portion of central frame member 14. Likewise a second transverse frame member 22 is bolted or welded to the central frame member 14 forward of frame member 24. An inverted U-shaped frame 28 is supported on opposite ends of transverse frame member 24. A pair of tie down members 30 are welded to frame 28. A third transverse frame member 32 is welded forward of frame member 22 to frame member 14 and to a front end of a right 34 and a left 36 converging side frame member. Back ends of right 34 and left 36 side frame members are welded to the second transverse frame member 22.

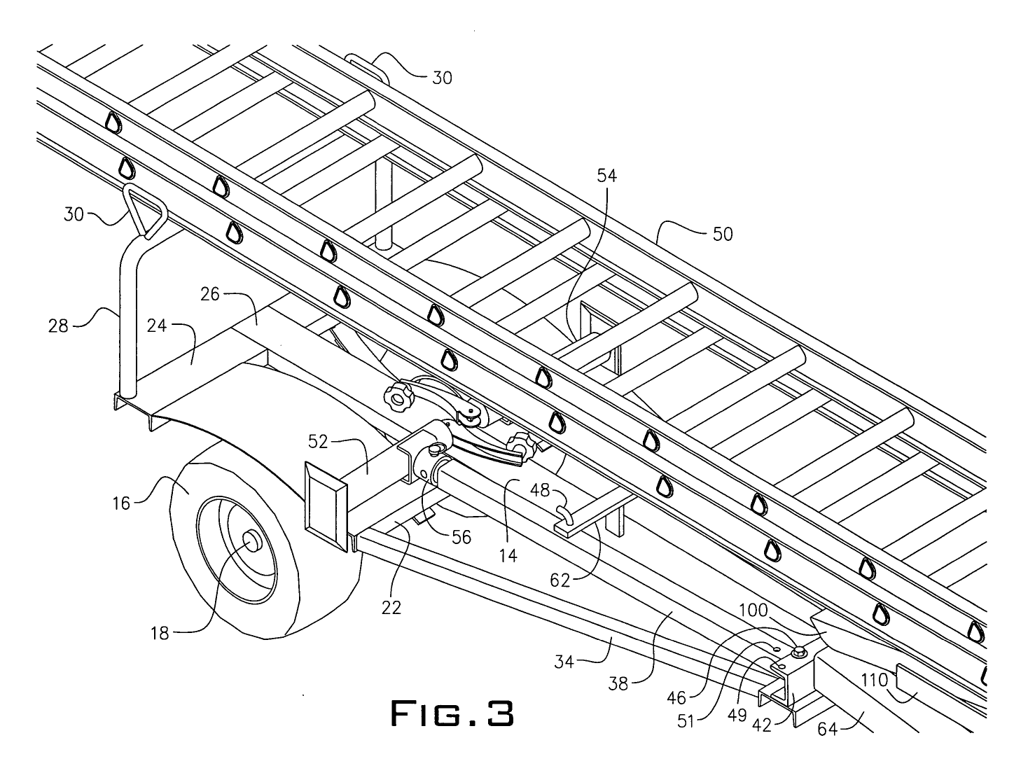

A right 38 and left 40 stabilizing arm pivots on pivot housings 42 and 44 respectively. Each pivot housing has a vertical bolt 46 on which the housing pivots. A pin 48 passes through openings 49 in the pin housing, and an opening 51 in the arms 38 and 40 to lock the stabilizing arms 38 and 40 in place while the ladder 50 is being raised. Right hydraulic lift 52 is attached to an end of right stabilizing arm 38 and left hydraulic lift 54 is attached to an end of left stabilizer arm 40. The lifts 52 and 54 are used to stabilize the trailer 12 while the ladder 50 is raised. When the ladder 50 is retracted and lying on the trailer 12 as seen in FIG. 3, the pins 48 have been removed from pivot housings 42 and 44, lifts 52 and 54 are retracted and pivoted on brackets 56 to a position at right angles to an end of the stabilization arms 38 and 40 respectively. Right hydraulic jack 52 and left hydraulic jack 54 rest on first transverse frame member 22. Pins 48 are then placed through hole 58 on the stabilization arms 38 and 40 and aligned in holes 60 on a T-bracket 62 welded to central frame 14.

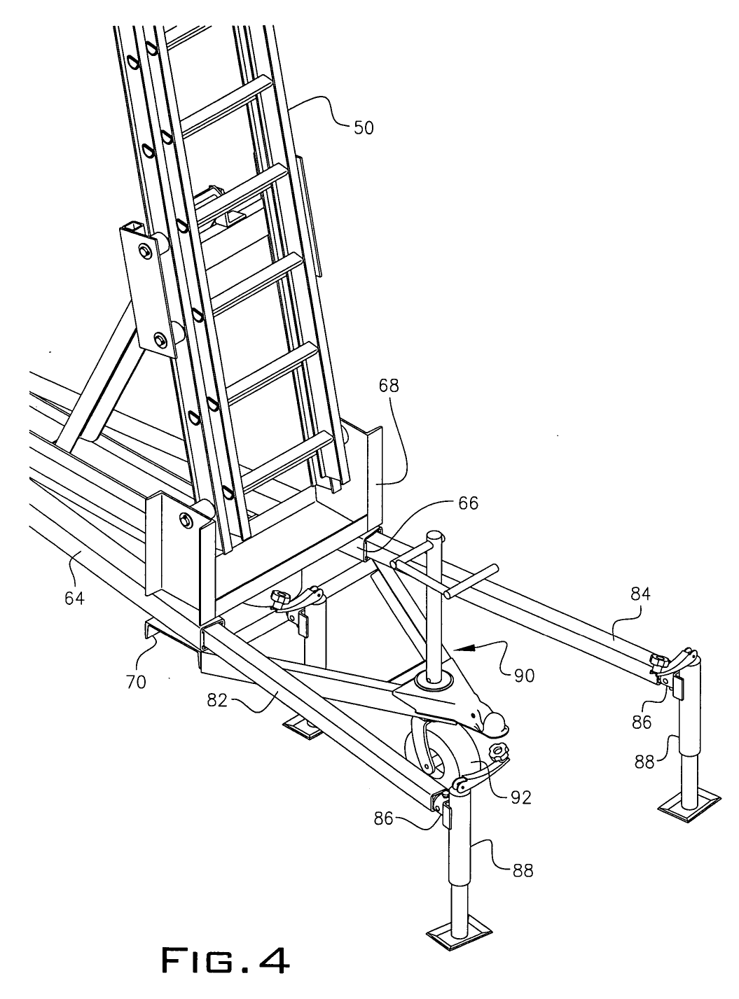

Right diverging side frame member 64 and left diverging side frame member 66 are welded at a back end to the third transverse frame member 32 and at a front end rest on fourth transverse frame member 70. A U-shaped bracket 68 rests on top of side members 64 and 66 as seen in FIG. 4.

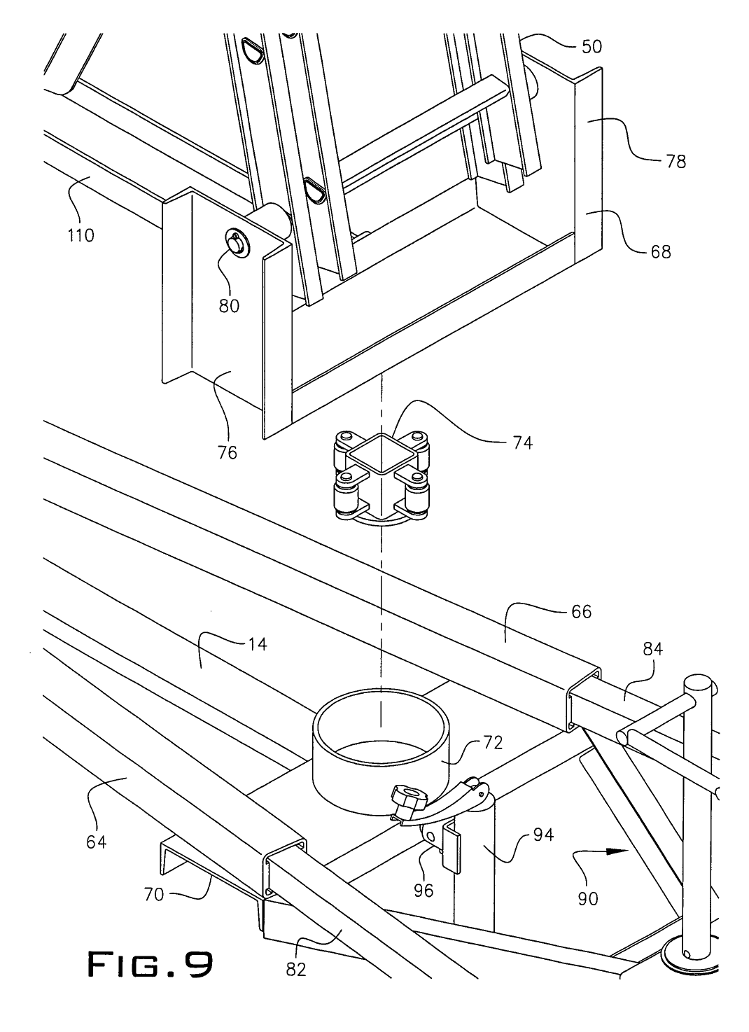

As seen in FIG. 9 an annular ring 72 is welded to a midpoint of bracket 68. A swivel bracket 74 is mounted within ring 72 so that U-shaped bracket 68 rests on a top portion of swivel bracket 74 and turns on swivel bracket 74. Upper arms 76 and 78 of bracket 68 have transverse bore holes through which a bolt 80 connects the legs of ladder 50 to the bracket 68.

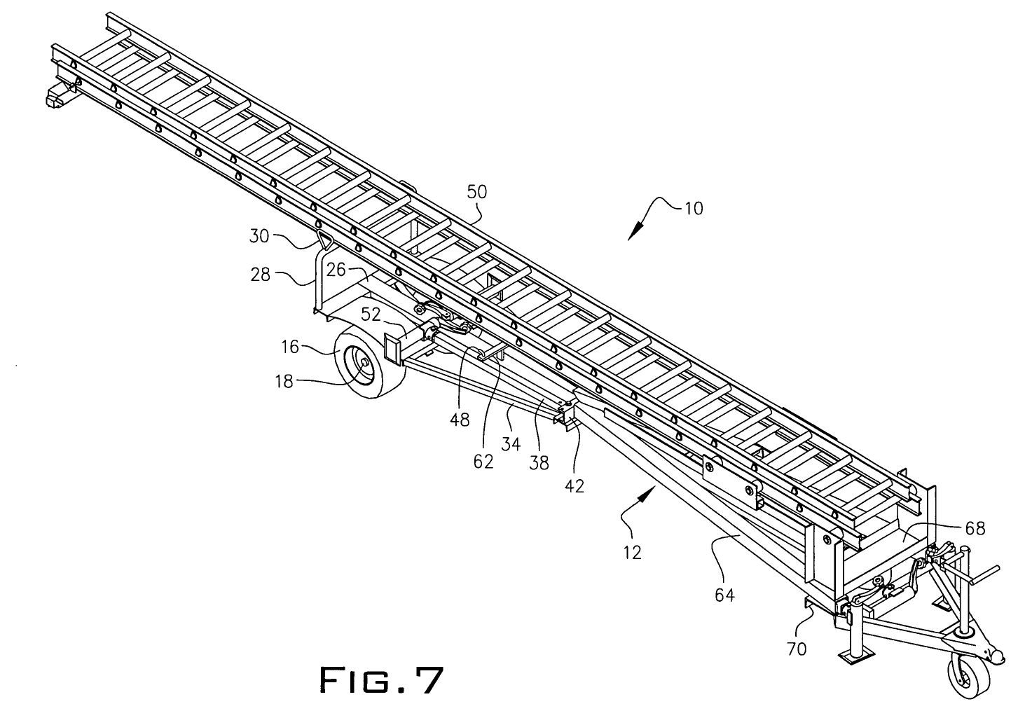

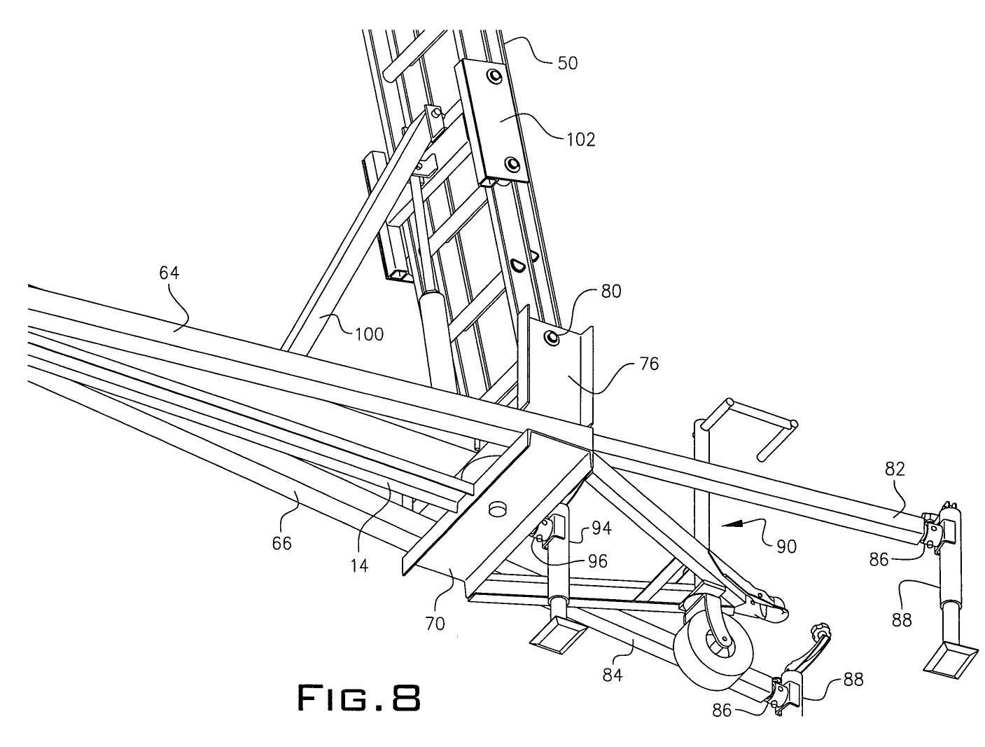

Referring again to FIG. 4, right extension arm 82 slides out from the inside of tubular frame member 64 and left extension arm 84 slides out from left tubular frame member 66. The ends of right extension arms 82 and 84 each have a bracket 86 attached to a hydraulic lift 88. As seen in FIG. 7, when the ladder is resting on the trailer 12 the arms 82 and 84 are returned inside tubular frame member 64 and 66 respectively and the hydraulic lifts are retracted in a resting position. A standard trailer A-frame 90 with a retractable wheel 92 is attached by welding to the fourth transverse member 70. An additional hydraulic lift 94 is mounted on a back portion of the A-frame 90 as seen in FIG. 8. This lift 94 pivots on a bracket 96 so it is parallel to the A-frame 90 back member when the ladder 50 is resting on trailer 12 as seen in FIG. 7.

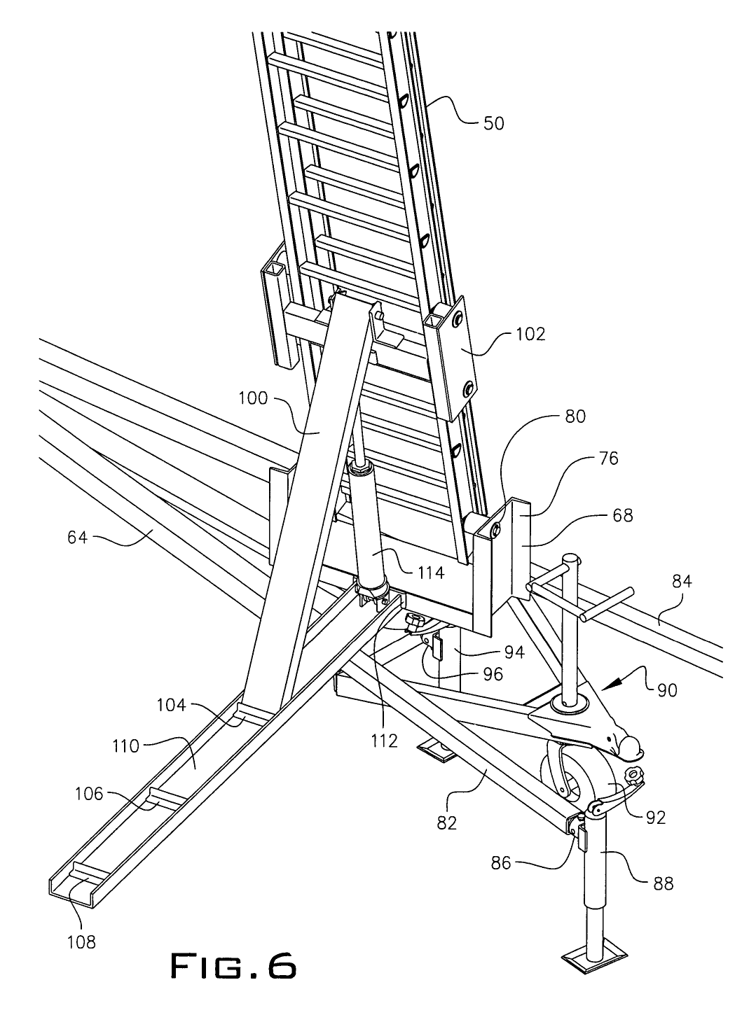

Referring to FIG. 6, a brace 100 is attached at a top end to a bracket 102 attached to ladder 50. At a bottom end it engages one of three stops 104, 106 or 108 in a brace support 110. A front end 112 of brace support 110 is welded to a back portion of U-shaped member 68. A hydraulic lift jack 114 rests on front end 112. As the jack 114 lifts ladder 50 the brace moves from over stop 108 as seen in FIG. 3 to top stop 104 as seen in FIG. 6. In the resting position of ladder 50, the brace 100 rests over brace support 110 under ladder 50.

The trailer and ladder of this invention are made from high quality steel. The hydraulic jacks employed are operated manually with the exception of jack 114 which is operated by battery power.

Equivalent components can be substituted for various elements in this ladder lift apparatus to provide substantially the same function in substantially the same way and with substantially the same result.

Having described the invention, what is claimed for Letters Patent follows:

1. An extension ladder pivotably mounted on a trailer adapted to be towed by a motor vehicle, the trailer and extension ladder combined apparatus comprising:
an elongated trailer having at least one pair of rear wheels connected by an axle, stop and directional lights mounted on a vertically mounted frame positioned rearwardly from the axle on a first transverse frame member welded to a central elongated longitudinal frame member, a second transverse frame member forward of the axle welded to the central elongated longitudinal frame member, a third transverse frame member forward of the second transverse frame member welded to the central elongated longitudinal frame member, and a fourth transverse frame member forward of the third transverse frame member welded to the central elongated longitudinal frame member, a right and left rear side frame member welded at a rear end to the second transverse frame member and welded at a converging front end to the third transverse frame member;
a pivotable bracket mounted on a first and second side of the third transverse frame member, each pivotable bracket attached to a first end of a stabilizing arm, a second end of the stabilizing arm pivotably attached to a hydraulic jack for stabilizing the trailer when the ladder is raised;
a right and left front side frame member welded at a converging rear end to the third transverse frame member and supported at a front diverging end by the fourth transverse frame member;
a swivel bracket mounted within a holder welded to the fourth transverse frame member;
a ladder bracket supporting the ladder pivoting on the swivel bracket;
a brace support welded to the ladder bracket;
a brace pivotably attached at a first end to the ladder and engaging a stop on the brace support when the ladder is raised; and
a hydraulic jack mounted on the brace support to raise the ladder.

2. The trailer and extension ladder combined apparatus according to claim 1, wherein a pin through bores in the pivotable bracket mounted on the first and second side of the third transverse frame member locks the stabilizing arms in place.

3. The trailer and extension ladder combined apparatus according to claim 1, wherein the holder welded to the fourth transverse frame member is an annular cylinder containing the swivel bracket.

4. The trailer and extension ladder combined apparatus according to claim 1, wherein the right and left front side frame members are tubular in shape and a stabilizing arm is slidable within each of the right and left front side frame members.

5. The trailer and extension ladder combined apparatus according to claim 4, wherein the stabilizing arms are extended out from a front end of each right and left side frame member and are attached to a hydraulic jack at an end distal from the front end of each right and left front side frame member.

6. The trailer and extension ladder combined apparatus according to claim 1, wherein a trailer A-frame is welded to a front portion of the fourth transverse frame member.

7. The trailer and extension ladder combined apparatus according to claim 6, wherein a front portion of the A-frame contains a hydraulic jack and wheel to support a front end of the trailer.

8. The trailer and extension ladder combined apparatus according to claim 1, wherein the ladder bracket is U-shaped and transverse bores on up-raised arms contain a bolt connecting the ladder bracket to the ladder.

9. The trailer and extension ladder combined apparatus according to claim 1, wherein the brace support and brace rest under the ladder when the ladder is being carried by the trailer underway.

10. A trailer and ladder combined apparatus comprising:
an elongated trailer having at least one pair of rear wheels connected by an axle;
a central longitudinal frame member extending from a rear portion to a front portion of the trailer;
a first, second, third and fourth transverse frame member spaced apart from the rear to the front portion of the trailer welded to the central longitudinal frame member;
a first stabilizing bar pivoting at a first end of the third transverse frame member and a second stabilizing bar pivoting at a second end of the third transverse frame member;
a right and left rear side frame member connecting the second transverse frame member to the third transverse side member;
a right and left front side frame member connecting the third transverse frame member to the fourth transverse side member;
a cylindrical member welded to a top surface of the fourth transverse side member enclosing a swivel bracket;
a U-shaped member having a base plate between uprightly extending arms, the base plate swiveling on the swivel bracket, the uprightly extending arms bolted to a bottom portion of the ladder;
a brace support welded to a back portion of the base plate;
a hydraulic jack attached to the brace support juxtaposed to the base plate at a bottom end of the jack and a top fixture on the jack attached to a ladder support bracket;
a brace attached at a first end to the ladder support bracket and engaging a stop on the brace support when the ladder is raised; and
stabilizing arms slidable within the right and left front side frame members so that the stabilizing arms are extended when the ladder is raised and a hydraulic jack at an end of each stabilizing arm supports the trailer.

11. A trailer and extension ladder combined apparatus according to claim 10, wherein an upright frame is mounted on the first transverse frame member to support the ladder when collapsed and underway on the trailer.

12. A trailer and extension ladder combined apparatus according to claim 11, wherein a tie-down member is mounted on a first and second side of the upright frame.

13. A trailer and extension ladder combined apparatus according to claim 10, wherein a T-bar is mounted on the longitudinal frame member between the second and third transverse member to receive the first and second stabilizing bars when the ladder is collapsed.

14. A trailer and extension ladder combined apparatus according to claim 10, wherein an A-frame is welded to a front portion of the fourth transverse member, the A-frame having a wheeled jack to support the frame.

15. A trailer and extension ladder combined apparatus according to claim 10, wherein the brace support has three spaced apart stops to engage a bottom portion of the brace.
